(19) United States
(12) Patent Application Publication
(10) Pub. No.: US 2009/0019706 A1
(43) Pub. Date: Jan. 22, 2009

(54) COMB ATTACHMENT

(76) Inventors: Edwin A. Werner, Union Grove, WI (US); Christopher J. Braun, Racine, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/171,776

(22) Filed: Jul. 11, 2008

Related U.S. Application Data
(60) Provisional application No. 60/949,388, filed on Jul. 12, 2007.

(51) Int. Cl. B26B 13/24

(52) U.S. Cl. 30/233.5

(57) ABSTRACT

A comb attachment for a hair trimmer includes a comb body having a leading edge and a rear portion. The rear portion is configured to couple the comb body to the hair trimmer. The comb attachment further includes a plurality of tines at the leading edge of the comb body, a magnet assembly configured to magnetically couple the comb attachment to the hair trimmer, and a recess formed in the rear portion of the comb body. The recess is configured to receive the magnet assembly.

### CROSS REFERENCE TO RELATED APPLICATIONS

The present patent application claims priority to U.S. Provisional Patent Application Ser. No. 60/949,388, entitled “COMB ATTACHMENT,” filed Jul. 12, 2007 by Edwin A. Werner and Christopher J. Braun, the entire content of which is hereby incorporated by reference.

### BACKGROUND

The present invention relates to comb attachments for hair trimmers, and in particular to means for removably coupling a comb attachment to a hair trimmer or clipper.

Combs are removably attachable to hair trimmers to assist an operator in cutting hair to achieve various styling textures and cuts. A standard comb attachment is used to control the length of hair being cut, whereby various comb attachments are used to create different hair cut lengths. Current comb attachments generally use springs or tabs to attach a blade to a comb attachment. However, plastic tabs may shear off when force is applied to the blades, and metal tabs may wear out and eventually provide a loose hold for the blade. Also, when metal tabs are new, they put a substantial amount of tension on the teeth of the comb caused by holding the blade so tightly. Such tension causes combs with smaller teeth to become unusable due to the teeth breaking off. Universal combs slide and lock onto the back of the blades, but some combs and blades lack sufficient area to allow for such attachment. Finally, inconsistent blade lengths make fitting a comb attachment to a blade difficult.

### SUMMARY

In one embodiment, the invention provides a comb attachment for a hair trimmer. The comb attachment includes a comb body having a leading edge and a rear portion. The rear portion is configured to couple the comb body to the hair trimmer. The comb attachment further includes a plurality of tines at the leading edge of the comb body, a magnet assembly configured to magnetically couple the comb attachment to the hair trimmer, and a recess formed in the rear portion of the comb body. The recess is configured to receive the magnet assembly.

In another embodiment, the invention provides a comb attachment for a hair trimmer. The comb attachment includes a comb body having a leading edge and a rear portion. The rear portion is configured to couple the comb body to the hair trimmer. The comb attachment further includes a plurality of tines at the leading edge of the comb body, a first magnet and a second magnet configured to magnetically couple the comb attachment to the hair trimmer, a first holder and a second holder configured to retain the first magnet and the second magnet, respectively, and a first recess and a second recess formed in the rear portion of the comb body. The first recess and the second recess are configured to receive the first holder and the second holder, respectively.

In another embodiment, the invention provides a comb attachment for a hair trimmer. The comb attachment includes a comb body having a leading edge and a rear portion. The rear portion is configured to couple the comb body to the hair trimmer. The comb attachment further includes a plurality of tines at the leading edge of the comb body, a magnet configured to magnetically couple the comb attachment to the hair trimmer, a holder configured to retain the magnet, and a recess formed in the rear portion of the comb body and configured to receive the magnet. The comb attachment further includes a shoulder positioned about an open end of the recess and a stand-off projecting into the recess from a closed end of the recess.

Other aspects of the invention will become apparent by consideration of the detailed description and accompanying drawings.

### BRIEF DESCRIPTION OF THE DRAWINGS

FIG. 1 is a top perspective view of a comb attachment according to one embodiment of the invention, the comb attachment illustrated attached to a blade of a hair trimmer.

FIG. 2 is a side perspective view of the comb attachment shown in FIG. 1.

FIG. 3 is a top view of the comb attachment.

FIG. 3A is a cross-sectional view of the comb attachment taken along line A-A of FIG. 3 and showing a magnet in a recess.

FIG. 4 is an exploded view of a magnet assembly of the comb attachment.

FIG. 5 is another cross-sectional view of the comb attachment without a magnet in the recess.

FIG. 5A is a detailed view of a portion of FIG. 5.

FIG. 6 is a bottom view of the comb attachment without the magnet of the invention.

FIG. 6A is a detailed view of a recess of FIG. 6.

FIG. 6B is a side view of the comb attachment of FIG. 6.

FIG. 7 is a perspective view of a holder of the invention.

FIG. 8 is a side view of the holder of FIG. 7.

FIG. 9 is a top view of the holder of FIG. 7.

FIG. 9A is a cross-sectional view of the holder taken along line A-A of FIG. 9.

FIG. 10 is a perspective view of a comb attachment according to another embodiment of the invention.

FIG. 11 is a perspective view of a comb attachment according to yet another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting.

### DETAILED DESCRIPTION

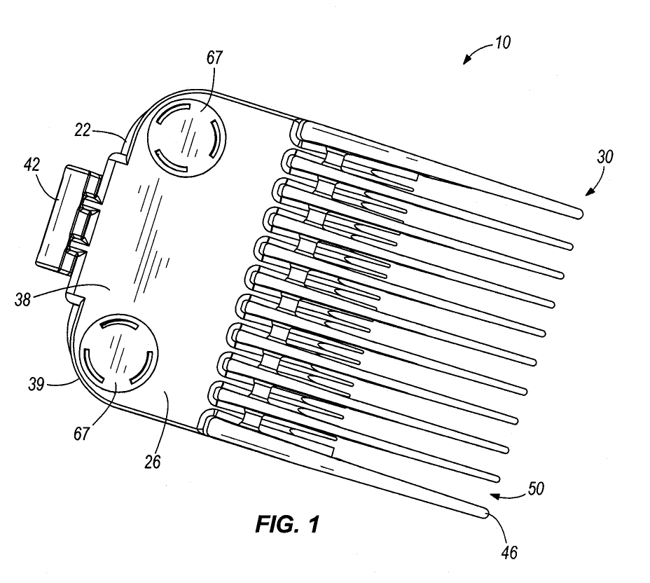

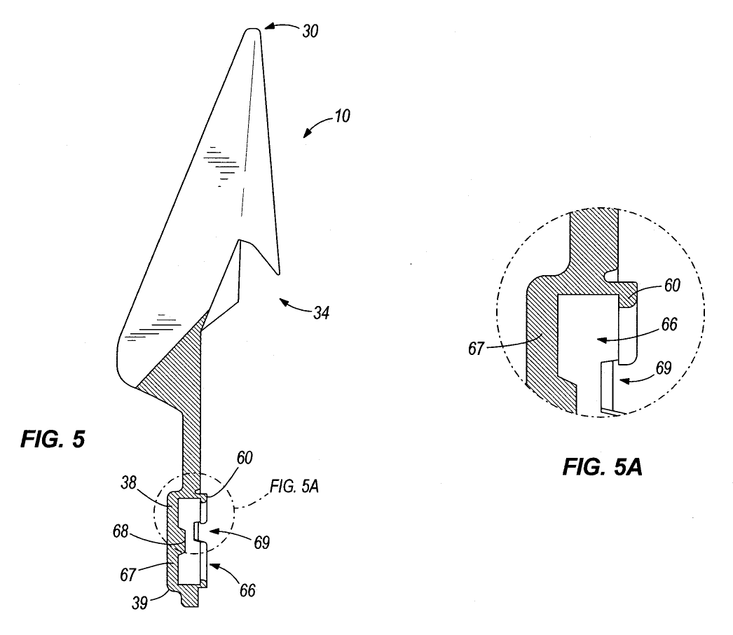

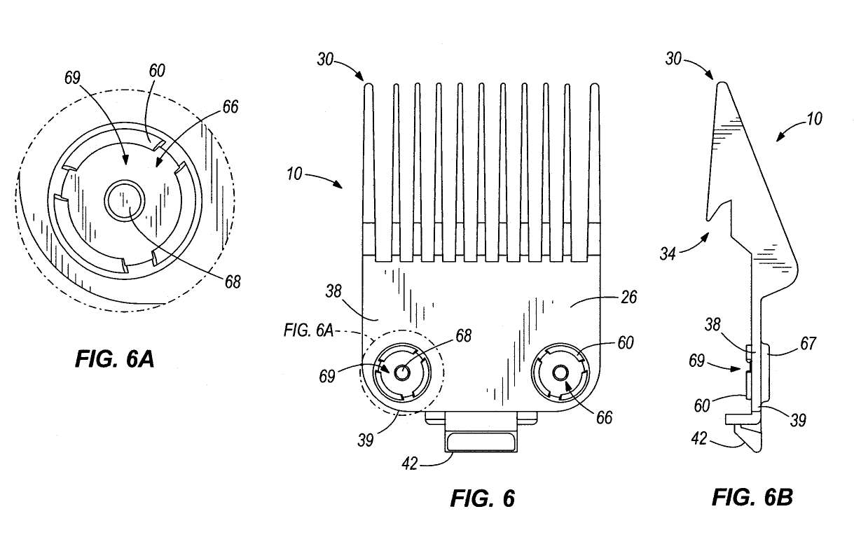

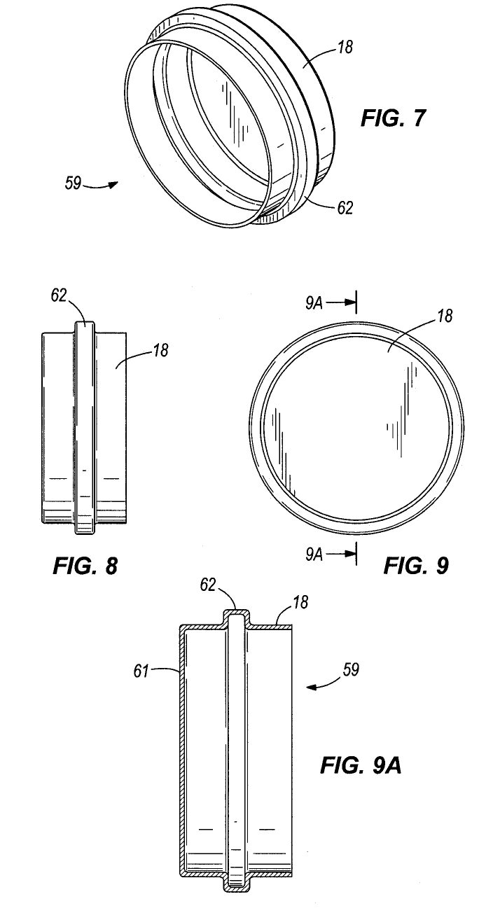

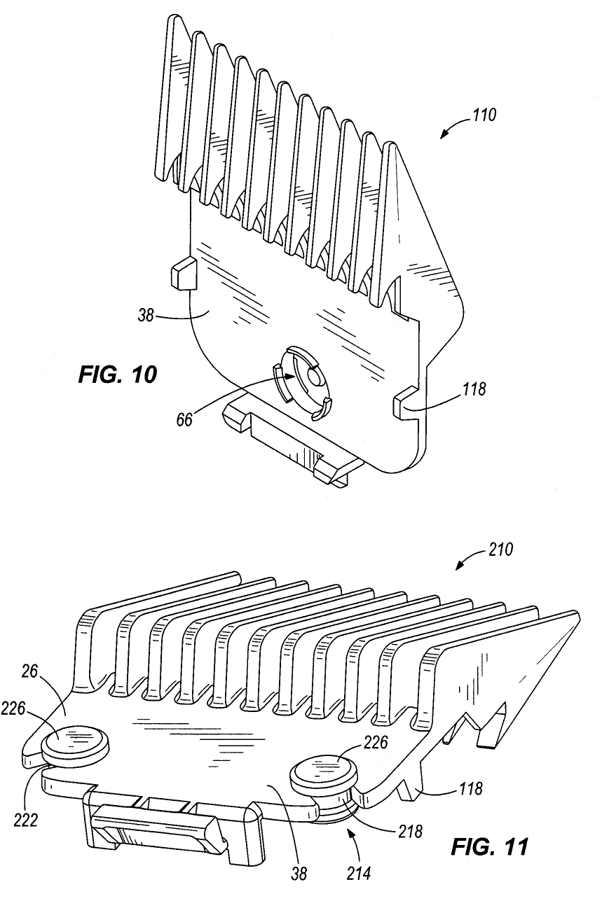

FIGS. 1-6B illustrate a hair comb attachment 10 and a magnet assembly 14 according to one embodiment of the invention. FIGS. 7-9A further illustrate a holder 18, or pot, of the magnet assembly 14. FIGS. 10 and 11 illustrate additional embodiments of the invention. It should be readily apparent to one of ordinary skill in the art that the present invention may also be utilized with a hair trimmer or hair clipper suitable for blade or comb attachment.

Referring to FIGS. 1-6B, the comb attachment 10 is removably coupled to a blade 22 for attaching the comb attachment 10 to a hair trimmer (not shown). The comb attachment 10 is used in conjunction with the hair trimmer to assist a user with the cutting and styling of hair.

The comb attachment 10 includes a comb body 26 having tines 46, a leading edge 30 of the comb body 26, which also defines the leading edge of the tines, a trailing edge 34 of the tines, a rear portion 38, a tab 42, and the magnet assembly 14. During use, the leading edge 30 generally contacts the hair to be cut before the trailing edge 34 contacts the hair to be cut. In the illustrated embodiment, the tines 46 define the leading edge 30 of the comb body 26, and adjacent tines 46 define a hair guide slot 50 to receive the hair to be cut. The comb attachment 10 is made of plastic.

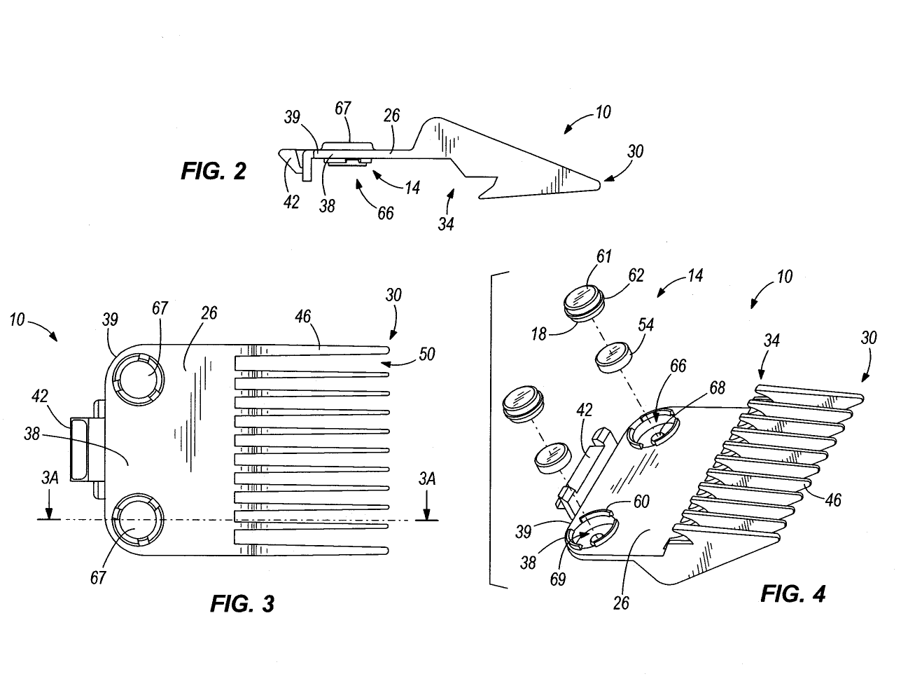

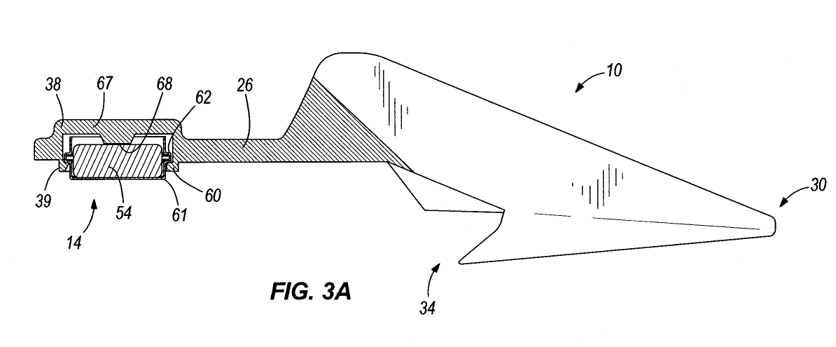

The rear portion 38 of the comb attachment is usually defined between the leading edge 30 and a rear edge 39 of the comb body 26. The rear portion 38 of the comb attachment 10 further includes recesses or receptacles 66 for receiving the magnet assemblies 14. In the illustrated embodiment, the comb attachment 10 includes two magnet assemblies 14 positioned substantially near corners of the rear portion 38. In other embodiments, the comb attachment may include one (FIG. 10), three, or more magnet assemblies. Each recess 66 has a closed end 67 and an open end 69. As illustrated in FIGS. 3A, 4, 5 and 6-6B, the comb attachment includes a nub or stand-off 68 projecting from the closed end 67 into the recess 66. The stand-off 68 provides guidance during placement of a magnet 54. The comb attachment also includes a shoulder 60 positioned about the open end 69 of the recess 66 (FIGS. 4, 5-5A and 6-6B). The recesses 66 are molded into the comb attachment 10 during manufacture of the comb attachment 10.

As shown in FIG. 4, the magnet assembly 14 includes the magnet 54 and the holder 18. In the illustrated embodiment, the magnet 54 is a Neodymium button magnet, however, in other embodiments, the magnet can be any type of magnet. The magnet 54 is pressed or otherwise placed into the holder 18, which is adapted to receive the magnet 54 (FIGS. 7-9A). The holder 18 provides support for the magnet 54. The holder 18 further includes a rib 62 formed on the exterior circumference of the holder 18 to provide additional support to the holder 18 while retaining the magnet and to provide for a snap-fit placement and retention within the recess 66 (FIG. 3A). The holder 18 includes an inner cavity 59 where the magnet 54 is placed and further includes a closed end 61 which is exposed during use to protect the magnet 54. The holder 18 is further adapted to be pressed into the recess 66 formed in the rear portion 38 of the comb attachment 10. The holder 18 is then snap-fit, press-fit, or otherwise retained by the shoulder 60 of recess 66. The holder 18 is made of steel; however, in other embodiments, the holder may be made of metal or similar material.

The magnets provide attraction points for the comb attachment 10 to couple to the metal blade 22 through magnetic attraction. At least one tab 42 (FIG. 4) at the rear of the comb attachment 10 further prevents the blade 22 from slipping off, sliding, or otherwise detaching from the comb attachment 10. In the illustrated embodiment, tab 42 is positioned at the rear of the comb attachment 10; however, in a further embodiment, tab 42 is positioned anywhere along the comb body 26. Tab 42 also provides an additional means to attach the comb attachment 10 onto the blade 22 with respect to the trimmer.

In operation, the magnet assembly 14 is positioned on the comb attachment 10 as shown in FIGS. 1-4 to attract the comb attachment 10 to the cutting blade 22. The cutting blade 22 is guided into place by the user and further guided by the shape of the comb attachment itself. The magnet assembly 14 provides magnetic attraction points for the blade 22 to enable coupling of the comb attachment 10 with blade 22. To remove the comb attachment 10 from the blade or trimmer, a user pushes on the rear portion 38 or tab 42 to overcome the force of the magnetic attraction.

FIG. 10 illustrates another embodiment of a comb attachment 110 according to the invention. The comb attachment 110 shown in FIG. 10 includes similar structure to the comb attachment and components illustrated in FIGS. 1-9; therefore, like structure is identified by the same reference numerals. Accordingly, with the exception of mutually inconsistent features and elements between the embodiment of FIG. 10 and the embodiments of FIGS. 1-6B, reference is hereby made to the description above accompanying the embodiments of FIGS. 1-6B for a more complete description of the features and elements (and the alternatives to the features and elements) of the embodiment of FIG. 10.

The comb attachment 110 includes one recess 66 centered in the rear portion 38 of the comb attachment 110 for receiving a magnet assembly (not shown). In the illustrated embodiment, the recess 66 is larger in size than the recess of the comb attachment 10 shown in FIGS. 1-6, which includes two recesses 66. Tab 118 provides support for the comb attachment 110 to stay on the blade and also guides placement of the comb attachment 110 onto the blade.

FIG. 11 illustrates yet another embodiment of a comb attachment 210 according to the invention. The comb attachment 210 shown in FIG. 11 includes similar structure to the comb attachment 10 and components illustrated in FIGS. 1-6B and comb 110 illustrated in FIG. 10 described above; therefore, like structure is identified by the same reference numerals. Accordingly, with the exception of mutually inconsistent features and elements between the embodiment of FIG. 11 and the embodiments of FIGS. 1-6B and FIG. 10, reference is hereby made to the description above accompanying the embodiments of FIGS. 1-6B and FIG. 10 for a more complete description of the features and elements (and the alternatives to the features and elements) of the embodiment of FIG. 11.

The comb attachment 210 includes two magnet assemblies 214 positioned at the rear portion 38 of the comb body 26. Each magnet assembly 214 includes magnets 218 machined or molded into a barbell-shape, wherein the magnet 218 is shaped like a column with two enlarged ends. The barbell shape provides additional support for the magnet and allows the magnet 218 to be slid onto the comb attachment 210 at slots 222 formed in the comb body 26. The slots 222 are shown as extending through an edge of the rear portion 38. The magnet assembly 214 may include a cover 226 to protect each end of the magnet and to further define the barbell shape.

In yet other embodiments, the magnet assembly includes a magnet machined with a rib. The rib provides a location for the magnet to be snap-fit or otherwise retained within the recess without a holder. The magnet is then snapped or pushed into place in the recess on the rear portion of the comb attachment. In yet another embodiment, the magnet can be molded directly into the comb attachment during the fabrication process, such that the magnet is integrated into the comb attachment during manufacturing.

Other embodiments of the present invention may utilize combinations of the above embodiments. The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

Various features and advantages of the invention are set forth in the following claims.

What is claimed is:

1. A comb attachment for a hair trimmer, the comb attachment comprising:
a comb body including a leading edge and a rear portion, wherein the rear portion is configured to couple the comb body to the hair trimmer;
a plurality of tines at the leading edge of the comb body;
a magnet assembly configured to magnetically couple the comb attachment to the hair trimmer; and
a recess formed in the rear portion of the comb body, the recess configured to receive the magnet assembly.

2. The comb attachment of claim 1 wherein the magnet assembly further comprises a magnet and a holder configured to retain the magnet.

3. The comb attachment of claim 2 wherein the magnet is a Neodymium button magnet.

4. The comb attachment of claim 2 wherein the holder includes a rib extending substantially around a circumference of the holder, the rib configured to retain the holder within the recess.

5. The comb attachment of claim 4 wherein the comb body includes a shoulder positioned about an open end of the recess, the shoulder configured to engage the rib to retain the holder within the recess.

6. The comb attachment tool of claim 1 wherein a portion of the recess extends through an edge of the comb body, and the portion of the recess receives the magnet assembly as the magnet assembly is slid into the recess.

7. The comb attachment of claim 6 wherein the magnet assembly is barbell shaped.

8. The comb attachment of claim 1, and further comprising a tab configured to further couple the comb attachment to the hair trimmer.

9. The comb attachment of claim 1 wherein the comb body includes a stand-off projecting into the recess from a closed end of the recess.

10. The comb attachment of claim 1 wherein the recess includes a plurality of recesses formed in the rear portion, each of the plurality of recesses configured to receive a magnet assembly.

11. A comb attachment for a hair trimmer, the comb attachment comprising:
a comb body including a leading edge and a rear portion, wherein the rear portion is configured to couple the comb body to the hair trimmer;
a plurality of tines at the leading edge of the comb body;
a first magnet and a second magnet configured to magnetically couple the comb attachment to the hair trimmer;
a first holder and a second holder configured to retain the first magnet and the second magnet, respectively; and
a first recess and a second recess formed in the rear portion of the comb body and configured to receive the first holder and the second holder, respectively.

12. The comb attachment of claim 11 wherein each of the holders includes a rib extending substantially around an exterior circumference of the holder, the rib configured to retain the holder in the recess.

13. The comb attachment of claim 12 wherein the comb body includes a shoulder positioned about each of the recesses, each of the shoulders configured to engage the rib of the respective holder to retain the holder in the recess.

14. The comb attachment of claim 11 wherein a portion of the first recess and a portion of the second recess extends through an edge of the comb body.

15. The comb attachment of claim 14 wherein the magnets are barbell shaped.

16. The comb attachment of claim 11 wherein the comb body includes a stand-off projecting into each of the recesses from a closed end of the respective recess.

17. A comb attachment for a hair trimmer, the comb attachment comprising:
a comb body including a leading edge and a rear portion, wherein the rear portion is configured to couple the comb body to the hair trimmer;
a plurality of tines at the leading edge of the comb body;
a magnet configured to magnetically couple the comb attachment to the hair trimmer;
a holder configured to retain the magnet;
a recess formed in the rear portion of the comb body and configured to receive the magnet;
a shoulder positioned about an open end of the recess; and
a stand-off projecting into the recess from a closed end of the recess.

18. The comb attachment of claim 17 wherein the holder includes a rib which extends substantially around a circumference of the holder to interact with the shoulder to retain the holder in the recess.

19. The comb attachment of claim 17 wherein the recess includes a plurality of recesses formed in the rear portion, each of the plurality of recesses configured to receive a magnet.

20. The comb attachment of claim 17 wherein the magnet is a Neodymium button magnet.
